(19) United States
(12) Patent Application Publication
(10) Pub. No.: US 2014/0245961 A1
(43) Pub. Date: Sep. 4, 2014

(54) Glossary for aquatic habitats

(71) Applicant: Daniel Kent Stanley, Tracy, CA (US)

(72) Inventor: Daniel Kent Stanley, Tracy, CA (US)

(21) Appl. No.: 13/573,873

(22) Filed: Oct. 9, 2012

(51) Int. Cl. A01K 63/00

(52) U.S. Cl. CPC A01K 63/006
USPC 119/248

(57) ABSTRACT

A vacuum induced aquatic environment comprising two or more compartments, each adapted to receive aquatic fluid; the two or more compartments disposed sufficiently proximal to each other to allow the aquatic fluid to partially or completely fill the two or more compartments; at least one of the two or more compartments operatively engaging one or more vacuum tubes; and the one or more vacuum tubes operatively engaging one or more motive means capable of creating a vacuum in the at least one of the two or more compartments. Alternatively, a vacuum induced aquatic environment further comprising one or more removable vacuum tubes.

### FIELD OF THE INVENTION

The present invention relates to a system for creating a vacuum in an elevated chamber in an aquatic environment.

### BACKGROUND OF THE INVENTION

Current designs of aquatic environments are flat and limited to traditional shapes and sizes. For example, in aquatic environments for fish, traditional rectangular, spherical, polygonal and other shapes are commonly used. However, these designs are static and do not provide for a more multi-dimensional view of fish nor provide the fish with a living area that goes beyond those shapes. Accordingly, there is a need for an aquatic system that provides aquatic organisms of various types whether fully or semi-aquatic with a further-dimensioned environment that transcends common shapes.

### SUMMARY OF THE PREFERRED EMBODIMENT

A vacuum induced aquatic environment comprising two or more compartments, each adapted to receive aquatic fluid; the two or more compartments disposed sufficiently proximal to each other to allow the aquatic fluid to partially or completely fill the two or more compartments; at least one of the two or more compartments operatively engaging one or more vacuum tubes; and the one or more vacuum tubes operatively engaging one or more motive means capable of creating a vacuum in the at least one of the two or more compartments.

Alternatively, the vacuum induced aquatic environment further comprising one or more removable vacuum tubes.

Alternatively, the vacuum induced aquatic environment wherein the one or more vacuum tubes operatively engaging the at least one of the two or more compartments further comprises a first end and a second end wherein the first end is disposed within the interior of the at least one of the two or more compartments and the second end operatively engages the one or more motive means.

Alternatively, the vacuum induced aquatic environment wherein the at least one of the two or more compartments operatively engaging one or more vacuum tubes further comprises a first end disposed sufficiently proximal to a first compartment and a second end disposed sufficiently proximal to a second compartment.

Alternatively, the vacuum induced aquatic environment wherein the at least one of the two or more compartments operatively engaging one or more vacuum tubes further comprises a support means for suspension into at least one other compartment.

Alternatively, the vacuum induced aquatic environment wherein the at least one of the two or more compartments operatively engaging one or more vacuum tubes further comprises one or more apertures disposed generally adjacent to a first end of the at least one of the two or more compartment which is disposed proximal to or within the aquatic fluid of another compartment.

Alternatively, the vacuum induced aquatic environment wherein the at least one of the two or more compartments operatively engaging one or more vacuum tubes further comprises one or more support legs.

Alternatively, the vacuum induced aquatic environment wherein the at least one of the two or more compartments operatively engaging one or more vacuum tubes further comprises means for securing it to a wall.

### BRIEF DESCRIPTION OF THE DRAWINGS

FIG. 1 is a side view of an aquatic environment with an elevated aquatic compartment having an upper supporting mechanism and internal vacuum tube

FIG. 2 is a perspective view of an aquatic environment with an elevated tube compartment

FIG. 3 is a top view of an elevated cylinder compartment with a detail view showing apertures in a raised lip for threading to support the compartment from above

FIG. 4 is a first side view of an elevated cylinder compartment with an internal vacuum tube used for creating a vacuum and raising the level of aquatic fluid inside the compartment

FIG. 5 is a second side view of an elevated cylinder compartment with an internal vacuum tube used for creating a vacuum and raising the level of aquatic fluid inside the compartment

FIG. 6 is a top view an elevated cylinder compartment with an internal vacuum tube used for creating a vacuum and raising the level of aquatic fluid inside the compartment

FIG. 7 is a side view of an elevated cylinder compartment and aquarium with an internal vacuum tube used for creating a vacuum and raising the level of aquatic fluid inside the compartment

FIG. 8 is a vertical view of an elevated cylinder compartment and aquarium with an internal vacuum tube used for creating a vacuum and raising the level of aquatic fluid inside the compartment

FIG. 9 is a top view an elevated cylinder compartment with an external vacuum tube used for creating a vacuum and raising the level of aquatic fluid inside the compartment

FIG. 10 is a side view of an elevated cylinder compartment with an external vacuum tube used for creating a vacuum and raising the level of aquatic fluid inside the compartment

FIG. 11 is a top view an elevated cylinder compartment with an external vacuum tube used for creating a vacuum and raising the level of aquatic fluid inside the compartment

FIG. 12 is a side view of an elevated cylinder compartment with an internal vacuum tube used for creating a vacuum and raising the level of aquatic fluid inside the compartment

FIG. 13 is a side view of an elevated cylinder compartment with an external vacuum tube used for creating a vacuum and raising the level of aquatic fluid inside the compartment

FIG. 14 is a top view an elevated cylinder compartment with an external vacuum tube used for creating a vacuum and raising the level of aquatic fluid inside the compartment

FIG. 15 is a side view of an elevated cylinder compartment disposed in an aquarium with an external vacuum tube used for creating a vacuum and raising the level of aquatic fluid inside the compartment

FIG. 16 is bottom view of an aquatic environment and elevated compartment using an internal vacuum tube for creating a vacuum and raising the level of aquatic fluid inside the compartment

FIG. 17 is a side view of one of many alternate shapes for creating an elevated compartment for creating a vacuum and raising the level of aquatic fluid inside the compartment

FIG. 18 is a side view of one of many alternate shapes for creating an elevated compartment for creating a vacuum and raising the level of aquatic fluid inside the compartment

### DETAILED DESCRIPTION

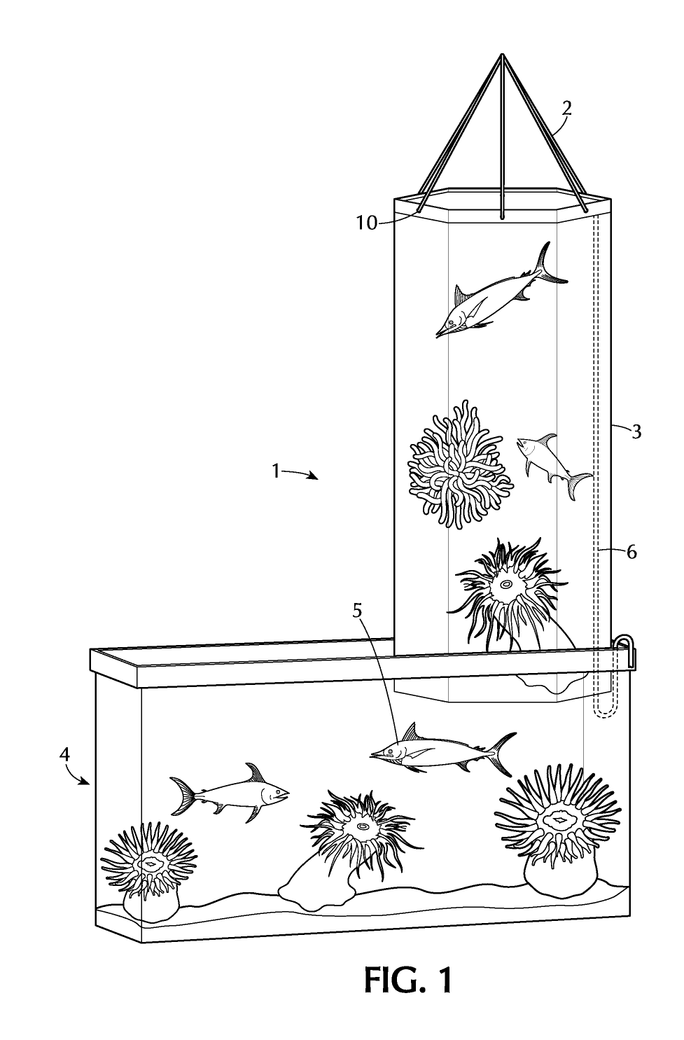

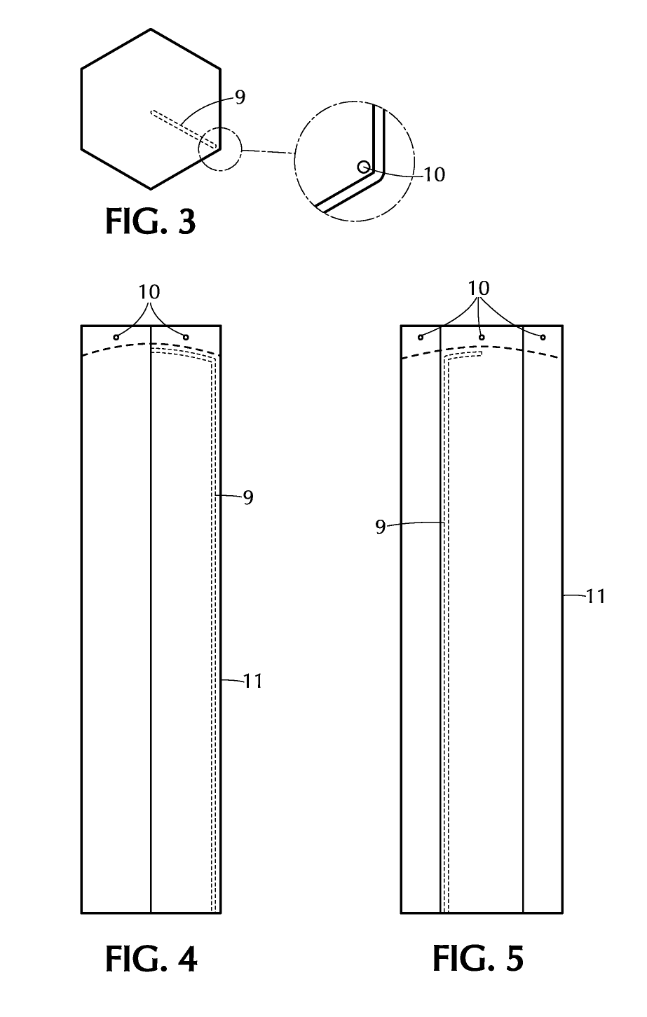

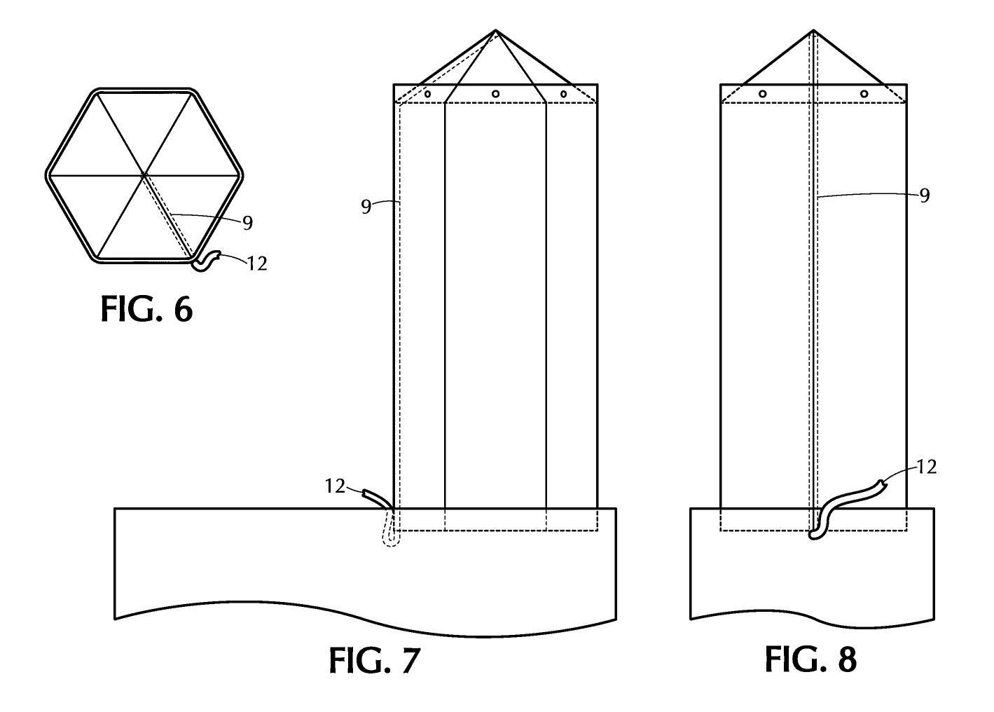

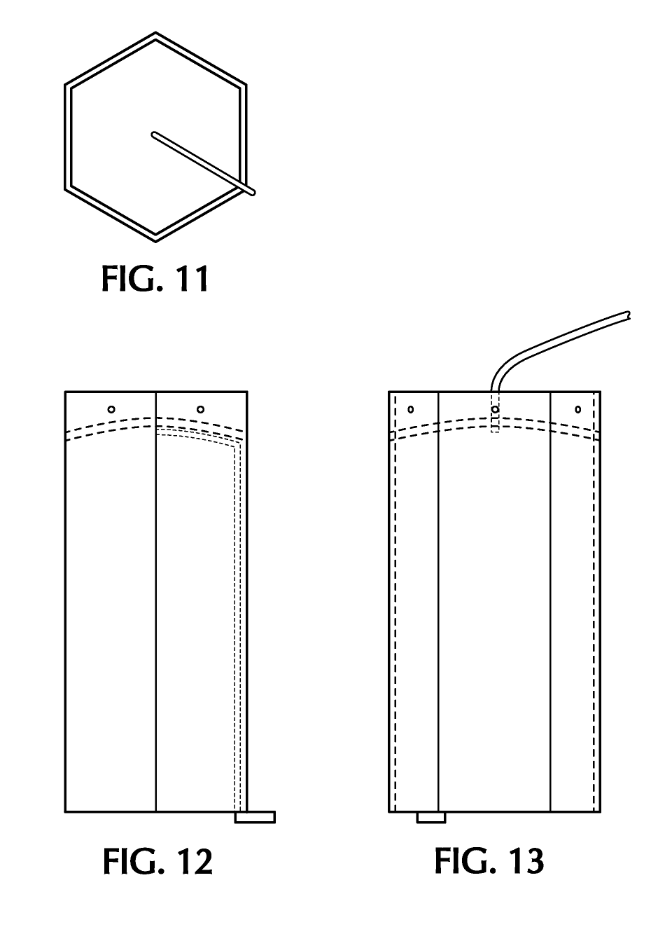

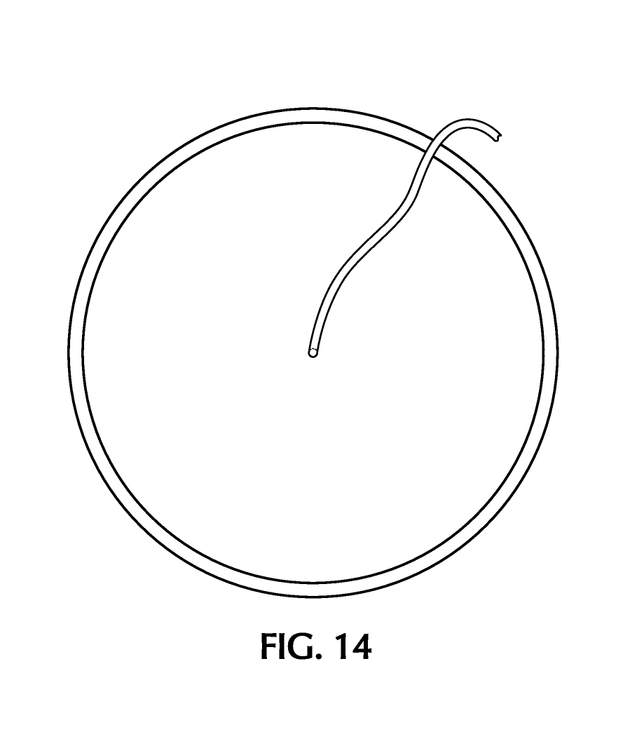

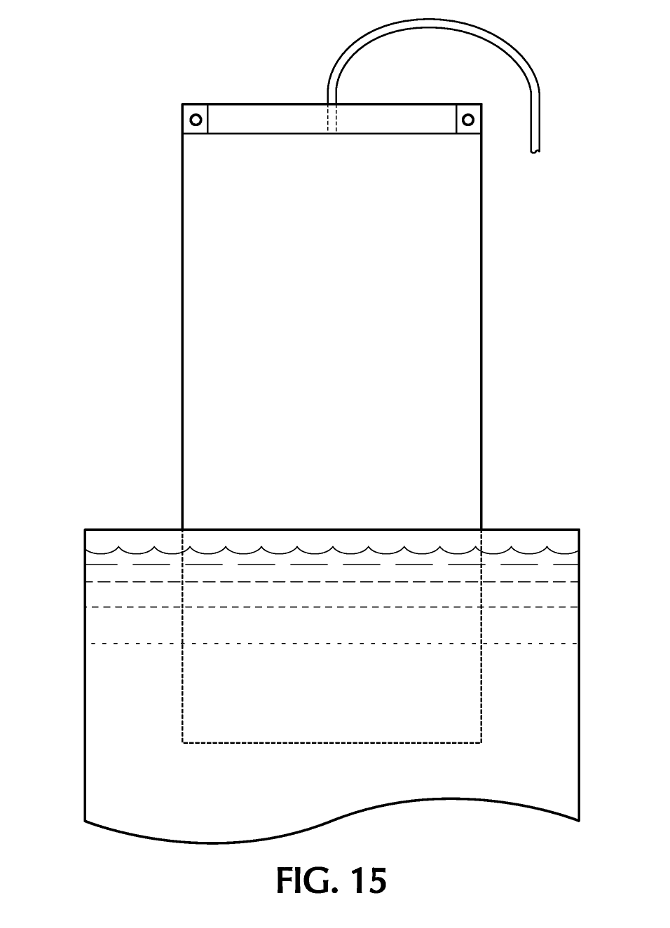

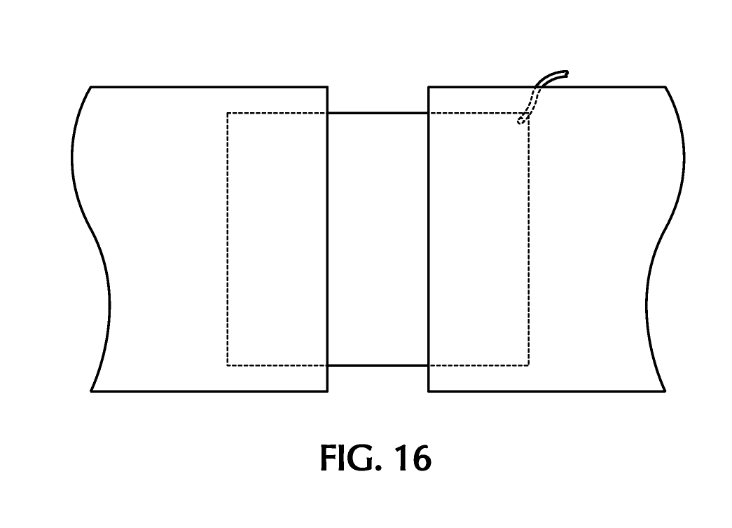

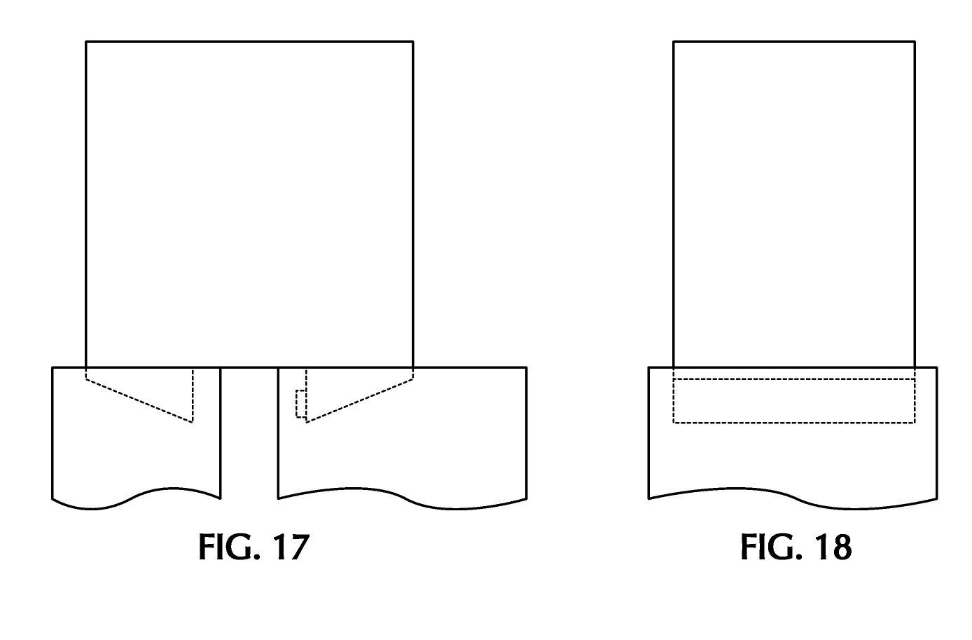

Referring to FIGS. 1-18 the present invention is directed to a device for creating an elevated compartment in an aquatic environment through the creation of a vacuum in the compartment to allow the filling of water, or any other desired medium, and provide additional aquatic space for aquatic or semi-aquatic animals. As used herein an “elevated compartment” means any configuration capable of sustaining water and aquatic life and wherein a vacuum can be created to reduce pressure in a compartment and allow water to fill it. Further, and although an elevated compartment is preferred, this same principle could be used for a submerged compartment or even one that is not elevated provided a vacuum can be created to fill the compartment with water or some other desired liquid. As used herein, “aquatic life” means any life, whether completely or even semi or partially aquatic, that would benefit from an increase of a confined aquatic space. As used herein, “vacuum” is an enclosed space from which any type of matter, most especially air, has been completely or partially removed so that the matter remaining in the space exerts less pressure than the atmosphere and allowing for fluid, most especially water, to fill that vacuum.

In a preferred embodiment, living organisms, such as fish, will have free access to additional living, or recreational space, in a body of water used for these activities without adding any water pressure or weight to their primary living space. This device we will call a compartment, enclosure, or chamber. In a preferred embodiment, and as shown in FIGS. 1, and 3-8, an elevated compartment 3 is supported by a threaded assembly 2 through apertures 10 on a lip of the compartment 3. Although a threaded support is shown, any known method for supporting the compartment can be used, such as legs, or other attachments to the top or side of the compartment. In this way the vacuum compartment can even be mounted to a wall or other supporting member. To achieve a vacuum in the compartment, a vacuum tube 6 can be either fixed or removably inserted into the compartment and where one end is disposed into the air of the compartment and the other end is disposed on the outside whereby a motive force, whether by mouth or some mechanical means can be used to draw air from the air in the compartment until a desired pressure inside the compartment is achieved. The hose may then be capped or removed through known means so as to prevent the vacuum from being breached by external pressure.

In another preferred embodiment, one or more apertures (not shown) may be disposed generally near the bottom of the compartment so that if the vacuum should be either slowly or immediately breached through the external pressure, and rather than having the entire body of water release at once, the water can be released in to a further aquatic chamber 4 at a more measured rate.

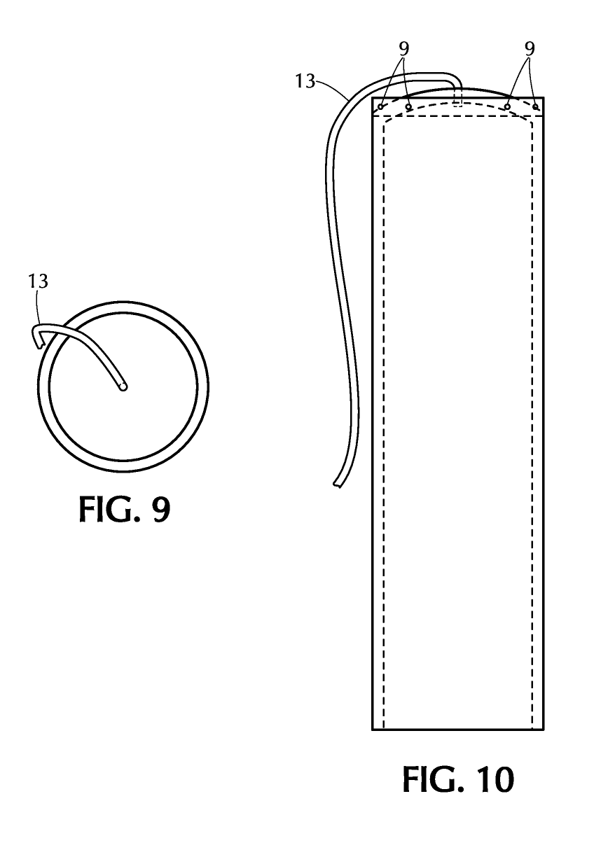

In another preferred embodiment, as shown in FIGS. 9, 10, 11, and 13-15, and rather than having an internal vacuum hose, an external hose may be used to create a vacuum inside a compartment. In this embodiment an external hose can be used and the motive force applied to withdraw air pressure from the compartment and the hose may be similarly capped.

In another preferred embodiment, a removable vacuum hose or “wand” could be used and which can be flexibly sufficient to bend to a desired rigid state to allow entry into the internal portion of a compartment and then to be removed after sealing the vacuumed chamber.

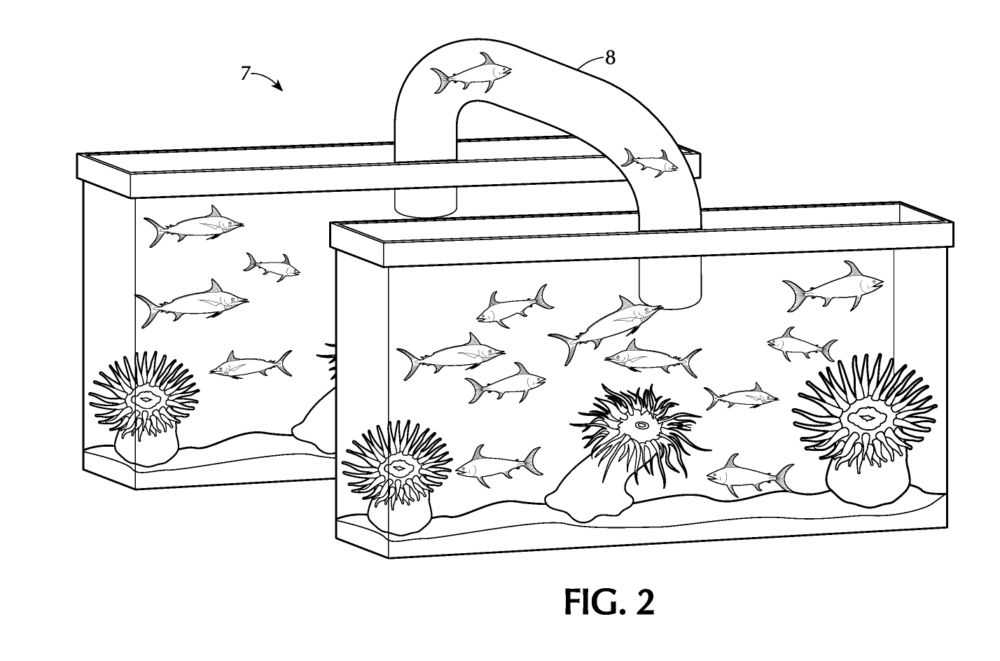

In another preferred embodiment a bridge, or multiple entry points of a compartment into one or more aquatic compartments can be accomplished. (See, FIG. 2) Although not shown, a vacuum can be accomplished through either an internal or external vacuum hose device as explained above. Alternatively, the above can be accomplished on the enclosure by building an enclosure with an open end at the bottom and placing that end of the enclosure onto the surface of a body of water, with all points of the open end two or three inches under the water surface, secure the enclosure so that the weight of it will not cause it to change the depth the rim is under water, and apply a vacuum to the enclosure, causing water to fill the cavity of the device. The bridge device would preferably be a tube, any shape or size that is open on both ends. The bridge can be supported from above through a flexible supporting member or a more permanent and rigid supporting member or other known means for securing to a wall or ceiling. One end is placed into a body of water to the depth necessary to keep air out of the tube. The other end is to be secured in the same manner as the first. All requirements, in order for this device to receive a vacuum, are the same as those in the aforementioned enclosure. The bridge device can be made of any other shape if it has two open surfaces that can be placed upon different bodies of water. The two water levels must be the same, or the device will draw water from the higher device to the lower.

In another preferred embodiment, anchors can be accomplished in several different ways for each of the living quarters, the enclosure and the bridge. As examples only, support from an overhead anchor, such as the ceiling of the room the enclosure is in. A framework can be made to provide the overhead anchor built of any material strong enough to support the weight of the enclosure; The enclosure can be secured to the anchor with the aide of ropes, chains, or straps, made of any material strong enough to support the weight of the enclosure; Legs extending from the edges of the opening in the enclosure down to the bottom of the container that holds the water. These legs must be strong enough to support the weight of the enclosure. The legs must not block the open end of the enclosure to provide easy access in and out to the organisms that wish to use the enclosure; Supports extending from the edge of the water container that are strong enough to support the weight of the enclosure; Supports extending from wall strong enough to support the weight of the enclosure; Supports from a stand or rack built for that purpose; A combination of any or all of the above mentioned supports.

In another preferred embodiment, to cause a vacuum in the enclosure you must remove the air. To accomplish this you can put a portal in the top of the enclosure and attach a hose to suck the air out. (See, E,g,, FIGS. 9 and 10) The air may also be removed by running a hose up the inside of the enclosure along the side all the way to the top, leaving one end of hose to extend around a lower lip of the opening and out of the water and used to vacuum air. Alternatively, a semi-rigid tubular wand may be used which is at least as long as the enclosure is deep; and then attach the hose on to the end of the wand to withdraw air. After securing the enclosure and the air is removed causing a vacuum to draw water up into the enclosure and so provides an additional volume of water. This volume can be as large or as small as the enclosure possesses.

Sometimes, the depth of the water in the enclosure is limited to the air pressure at its sight of setup. Changes in the weather can change the limits the depth can attain. As evaporation occurs, the water level may slowly drop. In a preferred embodiment, and when the water level drops below the rim it will let air in and water out. It is possible for a large volume to be lost at one time in a “flash-flow.” So, as a way to keep this from happening this embodiment allows you to make three to four 1/16-inch diameter holes 2 or 3 inches from the rim. These holes allow small amounts of air in and very small amounts of water out, negating water splashing over the edge of the container.

The shape of the enclosure holding water which makes contact with any compartment can be of any shape so long as the end or portion wherein water makes contact can make complete contact with the water to seal the vacuum.

Typically, the size of the enclosure is limited only by the strength of the materials it is made of. These materials must be airtight to retain its vacuum.

Overhead enclosure will not add any water pressure or weight to the container it sits on since, in an embodiment with supports, such as leg supports, the compartments weight is transferred to its adjacent aquatic container with water. Additionally, in another embodiment, an aquatic container's sides can support all the weight of the enclosure when secured to the sides of the container.

The foregoing embodiments are merely examples of the present invention. Those skilled in the art may make numerous uses of, and departures from, such embodiments without departing from the scope of the present invention. Accordingly, the scope of the present invention is not limited to or defined by such embodiments in any way but, rather, is defined solely by the following claims.

I claim:

1. A vacuum induced aquatic environment comprising:
Two or more compartments, each adapted to receive aquatic fluid;
The two or more compartments disposed sufficiently proximal to each other to allow the aquatic fluid to partially or completely fill the two or more compartments;
At least one of the two or more compartments operatively engaging one or more vacuum tubes; and
The one or more vacuum tubes operatively engaging one or more motive means capable of creating a vacuum in the at least one of the two or more compartments.

2. The vacuum induced aquatic environment of claim 1 further comprising one or more removable vacuum tubes.

3. The vacuum induced aquatic environment of claim 1 wherein the one or more vacuum tubes operatively engaging the at least one of the two or more compartments further comprises a first end and a second end wherein the first end is disposed within the interior of the at least one of the two or more compartments and the second end operatively engages the one or more motive means.

4. The vacuum induced aquatic environment of claim 1 wherein the at least one of the two or more compartments operatively engaging one or more vacuum tubes further comprises a first end disposed sufficiently proximal to a first compartment and a second end disposed sufficiently proximal to a second compartment.

5. The vacuum induced aquatic environment of claim 1 wherein the at least one of the two or more compartments operatively engaging one or more vacuum tubes further comprises a support means for suspension into at least one other compartment.

6. The vacuum induced aquatic environment of claim 1 wherein the at least one of the two or more compartments operatively engaging one or more vacuum tubes further comprises one or more apertures disposed generally adjacent to a first end of the at least one of the two or more compartment which is disposed proximal to or within the aquatic fluid of another compartment.

7. The vacuum induced aquatic environment of claim 1 wherein the at least one of the two or more compartments operatively engaging one or more vacuum tubes further comprises one or more support legs.

8. The vacuum induced aquatic environment of claim 1 wherein the at least one of the two or more compartments operatively engaging one or more vacuum tubes further comprises means for securing it to a wall.
